(19) United States
(12) Patent Application Publication
(10) Pub. No.: US 2006/0059782 A1
(43) Pub. Date: Mar. 23, 2006

(54) Cord support for window regulator

(75) Inventor: Jose Maria Garcia, Troy, MI (US)

Correspondence Address: WILLIAM M HANLON, JR;YOUNG & BASILE, PC, 3001 WEST BIG BEAVER ROAD, SUITE 624, TROY, MI, 48084-3107, US

(73) Assignee: HI-LEX Corporation, Troy, MI (US)

(21) Appl. No.: 10/945,195

(22) Filed: Sep. 20, 2004

(51) Int. Cl. E05F 11/00

(52) U.S. Cl. 49/358

(57) ABSTRACT

A motor vehicle door window glass regulator of the type including a carrier for mounting the window glass and mounted for reciprocal movement on the door to move the window glass between raised and lowered positions, an electrical motor carried by the carrier, an electrical cord connecting the motor to a source of electric power, and a drive mechanism operative in response to actuation of the motor to move the carrier reciprocally and thereby move the window glass between raised and lowered positions. The cord is mounted on an elongated articulated cord support extending linearly from the carrier to a fixed point on the door. The articulated cord support comprises a series of links receiving the cord and interconnected by live hinge portions and each link has a truncated pyramidal cross-sectional configuration. The minimum radius of the cord support and thereby of the cord is defined by the coming together of bevel end faces of adjacent links.

### FIELD OF THE INVENTION

This invention relates to window regulators for motor vehicles and more particularly to a cord support for use with a window regulator.

### BACKGROUND OF THE INVENTION

Window regulators have typically employed a moving carrier carrying the glass and a motor fixed in the door and arranged to power the carrier. More recently there has been a trend to fix the motor to the carrier in such a way that it travels with the carrier and the glass. This improves the overall efficiency of the system, but has a negative impact on system reliability. Specifically, as the motor moves up and down so does the power cord providing electrical power to the motor and repeated cable movement creates fatigue in the wire of the cord which leads to premature failure resulting in reduced system reliability and a higher warranty cost to the automaker and the consumer.

### SUMMARY OF THE INVENTION

This invention is directed to the provision of an improved window regulator for a motor vehicle.

More specifically this invention is directed to the provision of improved reliability for a window regulator of the type wherein the motor travels with the carrier.

This invention relates to a motor vehicle door window glass regulator of the type including a carrier for mounting the window glass and mounted for reciprocal movement on the door to move the window glass between raised and lowered positions; an electric motor carried by the carrier; an electric cord connecting the motor to a source of electrical power; and means operative in response to actuation of the motor to move the carrier reciprocally and thereby move the window glass between its raised and lowered positions.

According to the invention, the cord is mounted on an elongated articulated cord support extending linearly from the carrier to a fixed point on the door. This arrangement controls the flexing of the cord and specifically precludes pinching of the cord whereby to extend the cord life and system reliability.

According to a further feature of the invention, the articulated cord support comprises a series of links receiving the cord and interconnected by live hinge portions. This specific instruction provides a ready and efficient means of controlling the cord curvature during the movement of the carrier and the motor.

According to further feature of the invention, each link has a truncated pyramidal cross-sectional configuration constituted by a short parallel face, a long parallel face, and diverging bevel end faces interconnecting the parallel faces and the cord is mounted on the short parallel face of each link. This arrangement facilitates control of the radius of curvature of the cord.

According to further feature of the invention, each live hinge portion interconnects the long parallel faces of adjacent links whereby the minimum radius of the cord support and thereby of the cord is defined by the coming together of bevel end faces of adjacent links.

According to a further feature of the invention an upwardly opening, linearly extending snap-in groove is defined on the short parallel face of each link for snap-in receipt of a respective section of the cord.

### BRIEF DESCRIPTION OF THE DRAWINGS

The description herein makes reference to the accompanying drawings wherein like reference numerals refer to like parts throughout the several views, and wherein:

FIG. 1 is a side elevational, somewhat schematic view of a window regulator according to the invention;

FIGS. 2 and 3 are cross-sectional views taken on lines 2-2 and 3-3 respectively of FIG. 1;

FIG. 4 is a fragmentary top view of the invention window regulator;

FIGS. 5, 6, and 7 are fragmentary views of a cord support utilized in the invention window regular;

FIG. 8 is a fragmentary perspective view of an end link of the cord support; and

FIG. 9 is a fragmentary view illustrating a pinched electrical cord.

### DESCRIPTION OF THE PREFERRED EMBODIMENT

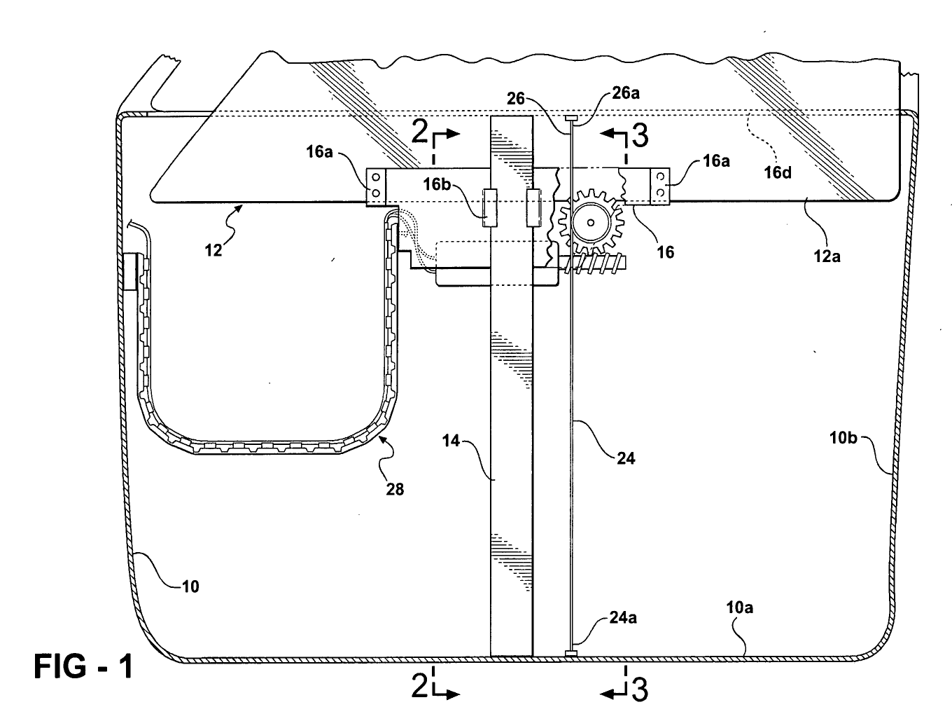

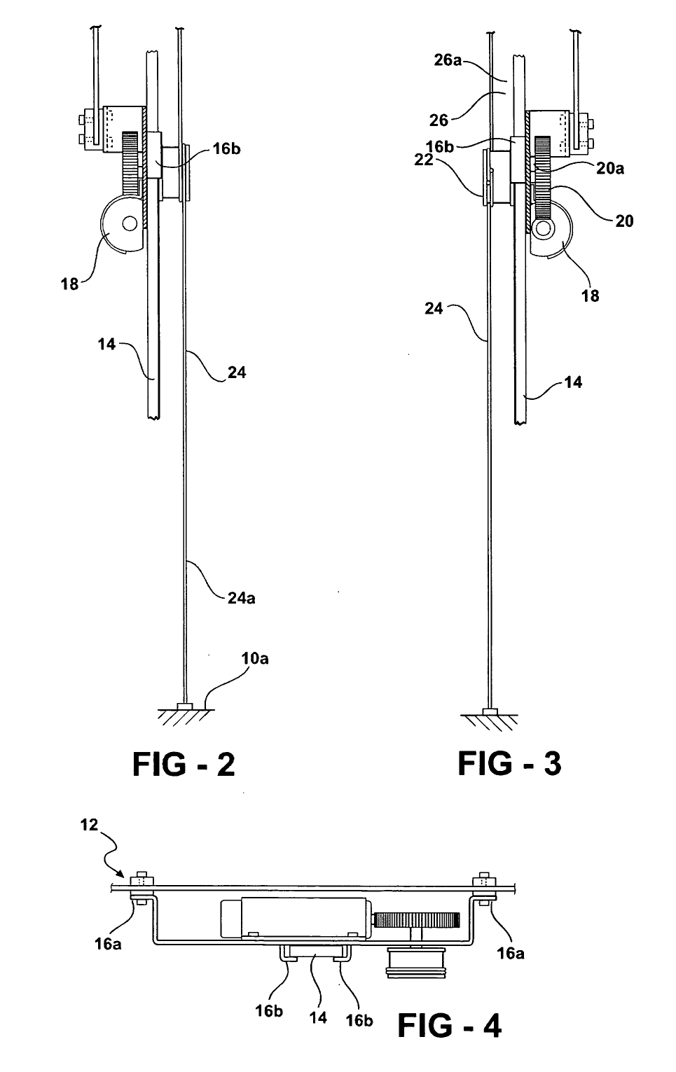

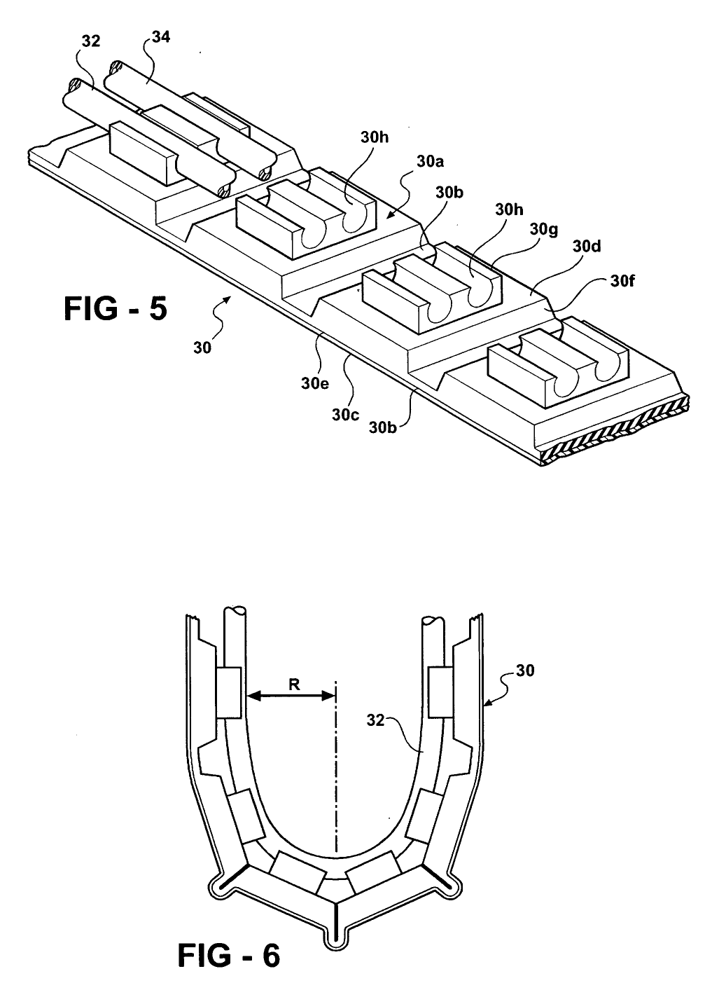

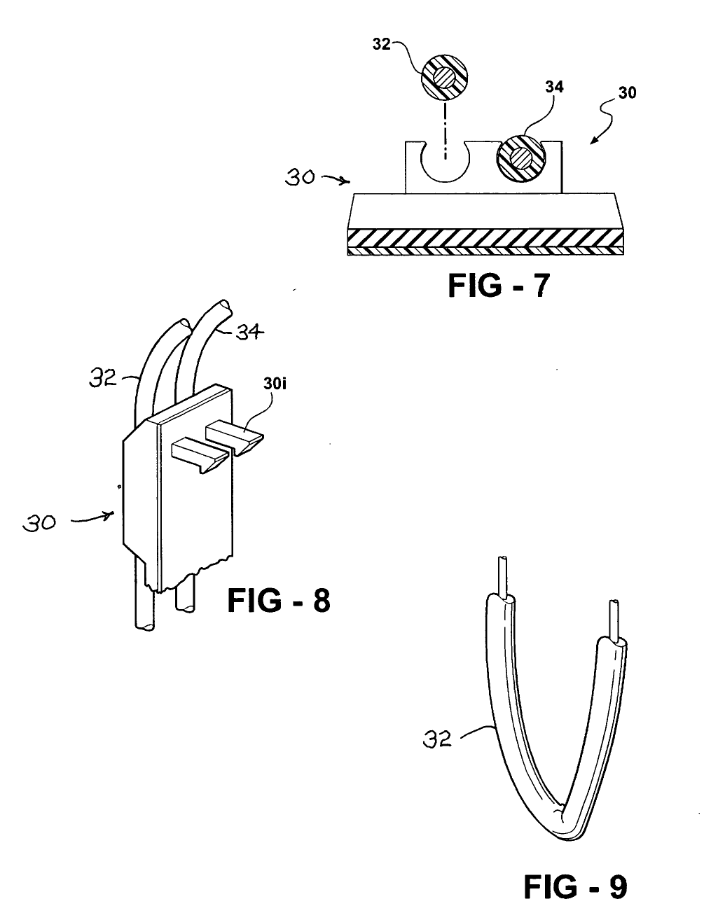

The window regulator of the invention is seen in FIG. 1 in association with a schematically shown motor vehicle door 10 having a frame structure 10a, 10b, 10c, and 10d and a window glass 12 arranged for reciprocal movement relative to the frame structure between raised and lowered positions.

The window regulator, broadly considered, includes a guide rail 14 extending vertically between door frame sections 10a and 10b, a carrier 16 having lug portions 16a fixedly secured to a lower region 12a on the window glass and guided for reciprocal sliding movement up and down the rail 14 by guide hooks 16b engaging opposite vertical edge faces of the rail; an electric motor 18 mounted on the carrier; a speed reduction gearing 20 driven by the output shaft of the motor 18 and having an output shaft 20a journaled in the carrier 16; a drum 22 mounted on the carrier 16 and driven by the output shaft 20a of the reduction gearing 20; a cable 24 wound in clockwise fashion around the drum 22 and fixed at its lower end 24a to door frame section 10a; a further cable 26 wound in counter clockwise fashion around the drum 22 and fixed at its upper end 26a to the door frame member 10d; and an electrical cord assembly 28 for delivering electrical power to the motor.

It will be understand that, in operation of the window regulator, energization of the motor 18 via the cord assembly 28 has the effect of turning the drum 22 to wind and unwind the cables 24 and 26 and thereby move the carrier 16, and the window glass 12, upwardly and downwardly along the guide rail 14 to move the window glass between raised and lowered positions.

Cord support assembly 28 includes a cord support member 30 and electrical cords 32 and 34. Cord support member 30 is elongated and articulated and specifically comprises a series of links 30a for receiving the cords and interconnected by live hinge portions 30b with a foam antirattle backing layer 30c. Each link 30a has a truncated pyramidal cross-sectional configuration constituted by short parallel face 30d, a long parallel face 30e, and diverging bevel end faces 30f interconnecting the parallel faces. Each link further includes a block portion 30g upstanding from the short parallel face 30d and defining a pair of upwardly opening linearly extending snap in grooves 30h for snap-in receipt of respective sections of the cords 32 and 34.

Each live hinge portion 30b interconnects the long parallel faces 30e of adjacent links whereby the minimum radius of the cord support and thereby of the supported cords is defined by the coming together of the bevel end faces 30f of adjacent links as best seen in FIG. 6. It will be seen that the cord support of the invention enables the system to be designed such that the minimum radius of curvature R of the cord greatly exceeds the minimum radius or pinch radius, as seen in FIG. 9, that might be encountered in the absence of the invention cord support.

The cord support extends linearly in catenary fashion between the carrier 16 and a section of the door such as the door frame section 10c and the attachment of the cord support at each end to the carrier and the door support respectively may be facilitated by providing the end links (FIG. 8) with catch prong portions 30i which are snappingly engaged in known manner with compatible structure on the carrier and on the door frame to facilitate the ready and secure attachment of the ends of the cord support to the carrier and door frame respectively. The ends of the cords proximate the door frame 10c will of course be connected to a suitable source of power and the ends of the cords proximate the carrier will of course be connected to plus and minus terminals on the motor 18 whereby to allow reversible energization of the motor to move the carrier and the glass upwardly and downwardly between the raised and lowered positions.

Whereas the dimensions and specifications of the cord support will vary depending upon the application, in one successful application the cord support was 260 mm long and 15 mm wide; each live hinge portion was 1.5 mm thick, each link was 3.00 mm thick and 15.0 mm long, and the material of the support was POM No. Glass.

The cord support of the invention will be seen to allow the use of a motor mounted on the window regulator carrier while avoiding the problem of cord fatigue and failure resulting from the constant flexing and/or pinching of the cord as the carrier and window glass repeatedly move upwardly and downwardly between the raised and lowered positions.

While the invention has been described in connection with what is presently considered to be the most practical and preferred embodiment, it is to be understood that the invention is not to be limited to the disclosed embodiments but, on the contrary, is intended to cover various modifications and equivalent arrangements included within the spirit and scope of the appended claims, which scope is to be accorded the broadest interpretation so as to encompass all such modifications and equivalent structures as is permitted under the law.

What is claimed is:

1. A motor vehicle door window glass regulator of the type including a carrier for mounting the window glass and mounted for reciprocal movement on the door to move the window glass between raised and lowered positions, an electric motor carried by the carrier, an electric cord connecting the motor to a source of electrical power, and means operative in response to actuation of the motor to move the carrier reciprocally and thereby move the window glass between its raised and lowered positions, characterized in that:
the cord is mounted on an elongated articulated cord support extending linearly from the carrier to a fixed point on the door.

2. A motor vehicle door window glass regulator according to claim 1 wherein:
the articulated cord support comprises a series of links receiving the cord and interconnected by live hinge portions.

3. A motor vehicle door window glass regulator according to claim 2 wherein:
each link has a truncated pyramidal cross sectional configuration constituted by a short parallel face, a long parallel face, and diverging bevel end faces interconnecting the parallel faces; and
the cord is mounted on the short parallel face of each link.

4. A motor vehicle door window glass regulator according to claim 3 wherein:
each live hinge portion interconnects the long parallel faces of adjacent links, whereby the minimum radius of the cord support and thereby of the cord is defined by the coming together of bevel end faces of adjacent links.

5. A motor vehicle door window glass regulator according to claim 4 wherein:
an upwardly opening linearly extending snap-in groove is defined on the short parallel face of each link for snap-in receipt of a respective section of the cord.

6. A motor vehicle door window glass regulator according to claim 1 wherein:
the cord support extends in catenary fashion between the motor and the fixed door point.

7. For use with a mechanism requiring the delivery of electrical energy from a fixed location to a moving electrical component utilizing an electric cord extending from the fixed location to the moving electrical component, an articulated elongated cord support member extending linearly from the fixed location to the moving component and including a series of links, means on the links for mounting the cord, and live hinge portions interconnecting the links.

8. An articulated cord support member according to claim 7 wherein:
each link has a truncated pyramidal cross sectional configuration constituted by a short parallel face, a long parallel face, and diverging bevel end faces interconnecting the parallel faces, and
the cord is mounted on the short parallel face of each link.

9. An articulated cord support member according to claim 8 wherein:
each live hinge portion interconnects the long parallel faces of adjacent links, whereby the minimum radius of the cord support member and thereby of the cord is defined by the coming together of bevel end faces of adjacent links.

10. An articulated cord support member according to claim 9 wherein the means on the links for mounting the cord comprises an upwardly opening axially extending snap-in groove defined on the short parallel face of each link for snap-in receipt of a respective section of the cord.

11. An articulated cord support member according to claim 7 wherein the cord support extends in catenary fashion between the moving electrical component and the fixed location.
